(19) United States
(12) Patent Application Publication
(10) Pub. No.: US 2013/0066813 A1
(43) Pub. Date: Mar. 14, 2013

(54) SYSTEM FOR PRICING INDIVIDUALLY QUOTED WHOLESALE FUEL PURCHASES

(71) Applicant: David McCaffrey, Manchester (GB)

(72) Inventor: David McCaffrey, Manchester (GB)

(73) Assignee: KNOWLEDGE SUPPORT SYSTEMS LTD, Manchester (GB)

(21) Appl. No.: 13/228,499

(22) Filed: Sep. 9, 2011

(51) Int. Cl. G06Q 30/02

(52) U.S. Cl. 705/413

(57) ABSTRACT

A computer-implemented method of generating fuel price data for at least one fuel type of a plurality of fuel types, the method being implemented in a computer comprising a memory in communication with a processor. The method comprises receiving, as input to the processor, unassigned delivery capacity data, the unassigned delivery capacity data indicating delivery capacity available for any one of the plurality of fuel types, receiving, as input to the processor, assigned delivery capacity data, the assigned delivery capacity data indicating, for each fuel type of the plurality of fuel types, delivery capacity only available for the fuel type of the plurality of fuel types and processing, by the processor, the assigned delivery capacity data and the unassigned delivery capacity data to generate the fuel price data for the at least one fuel type.

### TECHNICAL FIELD

The present invention relates to systems and methods for pricing fuel.

### BACKGROUND OF THE INVENTION

In many industries, commercial organisations have to determine prices at which their products are to be sold. Determination of such prices will need to take into account various factors but generally a commercial organisation aims to maximise profit from their products.

A particular industry in which prices need to be determined is the delivered fuel industry in which a vendor offers fuel for a certain price that includes delivery. For example, where a domestic household is not served by natural gas pipelines typically some form of delivered fuel such as heating oil or gas is used for space and water heating. Similarly, farms, small factories and building sites often use delivered fuel for heating, powering machinery and boilers and powering vehicles such as tractors. Such delivered fuel is delivered by a tanker truck into a fixed tank at a customer's premises.

Delivered fuel is typically purchased by contacting a call centre for a price quote for a particular delivery date. A telesales agent at the call centre typically has a customer relation management system (CRM) which displays the history of previous calls from the current caller, with the price quoted on each previous call, the volume and cost associated with the quote and whether or not the call was converted into a sale. The CRM typically additionally displays target prices or margins for each available product. The telesales agent uses the target prices or margins together to negotiate with the caller to agree a price, possibly based upon some other information associated with the call such as weather conditions at the time of the call (which may, for example, result in a higher price being offered during cold weather as demand is likely to be high) or the callers previous call history.

More recently, automated systems for determining fuel prices have been used. In these automated systems data required for determining pricing is collected and provided to a pricing system which uses the provided data together with other information to determine information useful for optimising fuel prices. The information generated by the pricing system generally takes the form of recommended pricing for fuels that satisfies the desired pricing.

There remains a need for improvements in pricing systems and methods.

### SUMMARY

It is an object of the invention to provide improvements in systems and methods for fuel pricing.

According to a first aspect of the invention there is provided a computer-implemented method of generating fuel price data for at least one fuel type of a plurality of fuel types, the method being implemented in a computer comprising a memory in communication with a processor. The method comprises receiving, as input to the processor, unassigned delivery capacity data, the unassigned delivery capacity data indicating delivery capacity available for any one of the plurality of fuel types and receiving, as input to the processor, assigned delivery capacity data, the assigned delivery capacity data indicating, for each fuel type of said plurality of fuel types, delivery capacity only available for said fuel type of said plurality of fuel types. The assigned delivery capacity data and the unassigned delivery capacity data are processed, by the processor, to generate the fuel price data for said at least one fuel type.

By generating fuel price data for a fuel type based upon assigned and unassigned delivery capacity in this way, fuel price data can be determined that takes into account available capacity for delivery of particular types of fuel as well as capacity for delivery of any type of fuel, and improved fuel price data can be determined. For example, where a relatively small amount of capacity remains it may be desirable to increase fuel prices to maximise the profit from the small amount of remaining capacity, whereas where a relatively large amount of capacity remains it may be desirable to decrease prices to sell more fuel. Whilst prior art methods may have considered problems of pricing in the light of capacity, such methods have not considered a system in which some delivery capacity is constrained to a particular fuel type.

The method may further comprise receiving, as input to the processor, a request for a delivery of one of said plurality of fuel types, said request being associated with a quantity of fuel. The processing may comprise determining, by the processor, a maximum expected revenue based upon the unassigned delivery capacity data and the assigned delivery capacity data and determining an effect upon the maximum expected revenue associated with accepting the request.

In this way, an associated cost to possible profit that can be made from that capacity (sometimes referred to as an opportunity cost) can be taken into account when generating the fuel price data.

Determining the effect upon the maximum expected revenue may comprise determining, by the processor, a further maximum expected revenue, the further maximum expected revenue being based upon said assigned delivery capacity data, said unassigned delivery capacity data and said quantity of fuel associated with said request and determining a difference between the first maximum expected revenue and the second expected maximum revenue.

The effect upon maximum expected revenue may be determined based upon a rate of change of a profit rate associated with a maximum expected revenue without accepting the request. For example the maximum expected revenue may be determined by differentiating the profit rate associated with the maximum expected revenue without accepting the request.

Determining a maximum expected revenue may comprise processing, by the processor, at least one model defining a relationship between a demand rate associated with a fuel type of the plurality of fuel types, the unassigned delivery capacity data and the assigned delivery capacity data. The model may define a fluid approximation problem.

The method may further comprise receiving, as input to the processor, a plurality of arrival models, each of the demand rates having an associated arrival model, each of the arrival models being arranged to provide an expected rate of requests associated with the demand rate and receiving, as input to the processor, a plurality of willingness to pay models, each of the demand rates having an associated willingness to pay model, each of the willingness to pay models being arranged to provide a probability of conversion of a request for a delivery associated with a price and the demand rate. The demand rate for each of the plurality of fuel types may be based upon the arrival model associated with the fuel type and the willingness to pay models associated with the fuel types. Each arrival model may indicate a total number of expected requests for a particular fuel type and each willingness to pay model may model a relationship between a price offered and a probability that a customer will accept that offer.

Each request may be associated with a segment of a plurality of segments, each segment being associated with a classification of requests, and the demand rate may be associated with a fuel type of the plurality of fuel types and a segment of the plurality of segments. The segments may generally group together customers sharing particular properties, for example a typical size of delivery or a likelihood of the customer placing an order.

Processing at least one model defining a relationship between a demand rate associated with each of the plurality of fuel types may comprise generating, by the processor, a plurality of assignments assigning the unassigned delivery capacity to the plurality of fuel types. For each of the generated plurality of assignments, a model associated with a demand rate associated with each of the plurality of fuel types, the assigned delivery capacity and the assignment types may be processed to determine an expected revenue associated with the assignment and a maximum one of the expected revenues associated with the assignments may be selected. That is, a plurality of different possible assignments for the unassigned delivery capacity may be processed to determine an expected revenue for each assignment. The unassigned delivery capacity may comprise a plurality of sub capacities, and each of the assignments may assign the whole of a sub capacity to one of the plurality of fuel types. The sub capacities may correspond to delivery vehicles.

That is, the total possible capacity for carrying fuel may be divided into a number of discrete units, such as delivery vehicles, and each delivery vehicle will typically only be able to carry one of the plurality of different fuel types given that mixing is not generally possible in a delivery vehicle. If a fuel type is assigned to a particular vehicle then the total capacity of the delivery vehicle is effectively assigned to that fuel type. There is typically one assignment of delivery vehicles that allows revenue to be optimised, given expected requests for the various different fuel types and likelihood of conversion to a sale of those requests at different prices. By processing a plurality of different possible assignments to determine an expected revenue for each assignment a more accurate cost associated with accepting a call can be determined and profit can therefore be optimised.

Generating a plurality of assignments may comprise processing, by the processor, a model defining a relationship between a demand rate associated with each of the plurality of fuel types and the unassigned delivery capacity to determine an unconstrained expected revenue and determining, by the processor, an unconstrained assignment assigning the delivery capacity to the plurality of fuel types based upon the unconstrained expected revenue and generating the plurality of assignments based upon the unconstrained assignment. In this way, the number of assignments that are processed to determine an expected revenue can be reduced and the computational complexity of the problem is also reduced.

Generating the plurality of assignments based upon the unconstrained assignment may comprise determining, by the processor, a sub capacity assigned to more than one of the fuel types in the unconstrained assignment and generating, by the processor, for each of the fuel types assigned to the sub capacity, an assignment in which the sub capacity is assigned to the fuel type. In particular, it can first be assumed that fuel types can be mixed in a delivery vehicle to determine an unconstrained expected revenue, and that unconstrained expected revenue has an associated assignment. The delivery vehicles in that assignment that are assigned to two or more fuel types can then be processed to determine an expected revenue with the vehicles assigned to each of the two or more fuel types.

The processing may further comprise performing, by the processor, an optimisation operation, the optimisation operation being based upon the effect upon the maximum expected revenue associated with accepting the request. The optimisation operation may be further based upon a cost associated with the request. The cost associated with the request may be a cost of raw materials and/or a cost of delivery.

The optimisation operation may be further based upon a conversion model, the conversion model modelling a relationship between a price and a probability of conversion to sale of the request. The conversion model may be generated for the particular request, for example based upon information associated with a customer making the request.

According to a second aspect of the invention there is provided a computer-implemented method of generating fuel price data for a fuel type, the method being implemented in a computer comprising a memory in communication with a processor. The method comprises receiving, as input to the processor, customer data indicating a customer request for fuel of said fuel type at a first time and receiving, as input to the processor, capacity data indicating assigned delivery capacity at said first time. The fuel price data is generated, by the processor, based upon the customer data and the capacity data.

In this way, a customer request for fuel and assigned delivery capacity may be used to generate improved fuel price data. That is, the fact that a customer request for fuel will affect the delivery capacity and correspondingly may have an associated cost to possible profit that can be made from that capacity (sometimes referred to as an opportunity cost) can be taken into account when generating the improved fuel price data.

The customer data may be received at a first node from a second node and the method may further comprise transmitting the generated fuel price data to the second node. That is, customer data and fuel price data may be transmitted between nodes. The capacity data may be received from a third node. The first, second and third nodes may be computers and the data may be transmitted over a network. The second node may be located at a first location such as a call centre and the first node may be located at a second different location. The third node may be located at a third location such as a delivery vehicle depot. In some embodiments the second and third locations may be the same location.

The capacity data may further indicate unassigned delivery capacity at the first time. The generating may comprise determining, by the processor, a maximum expected revenue for the first time based upon the capacity data and determining an effect upon the maximum expected revenue associated with accepting the request.

The customer data may further indicate a segment associated with the customer, and the segment may be associated with historical customer requests for fuel received from the customer.

According to a third aspect of the invention there is provided a computer-implemented method of determining an effect upon maximum expected revenue of a request for a delivery of one of a plurality of fuel types, the request being associated with a quantity of fuel, the method being implemented in a computer comprising a memory in communication with a processor. The method comprises receiving, as input to the processor, unassigned delivery capacity data, the unassigned delivery capacity data indicating delivery capacity available for any one of the plurality of fuel types and processing, by the processor, a model defining a relationship between a demand rate associated with each of the plurality of fuel types and the unassigned delivery capacity to determine an unconstrained maximum expected revenue. An unconstrained assignment assigning the delivery capacity to the plurality of fuel types is determined, by the processor, based upon the unconstrained maximum expected revenue and a plurality of assignments assigning the unassigned delivery capacity to the plurality of fuel types is generated, by the processor, based upon the unconstrained assignment. The effect upon maximum expected revenue is determined by the processor based upon the plurality of assignments.

By generating a plurality of assignments assigning unassigned delivery capacity to the plurality of fuel types based upon an unconstrained assignment in this way, the number of assignments that are processed can be reduced without unduly affecting the quality of the determination of the effect upon maximum expected revenue of a request for a delivery.

The unassigned delivery capacity may comprise a plurality of sub capacities, and each of the assignments may assign the whole of a sub capacity to one of the plurality of fuel types. The sub capacities may correspond to delivery vehicles.

Generating the plurality of assignments based upon the unconstrained assignment may comprise determining, by the processor, a sub capacity assigned to more than one of the fuel types in the unconstrained assignment and generating, by the processor, for each of the fuel types assigned to the sub capacity, an assignment in which the sub capacity is assigned to the fuel type.

It will be appreciated that aspects of the invention can be combined.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of an arrangement for sale of delivered fuel to a plurality of customers;

FIG. 1A is a schematic illustration of a computer of the arrangement of FIG. 1;

FIG. 2 is a flowchart showing processing to determine a suggested price for a customer;

FIG. 3 is a flowchart showing processing to determine an opportunity cost; and

FIG. 4 is a flowchart showing processing to enumerate delivery vehicle assignments.

### DETAILED DESCRIPTION

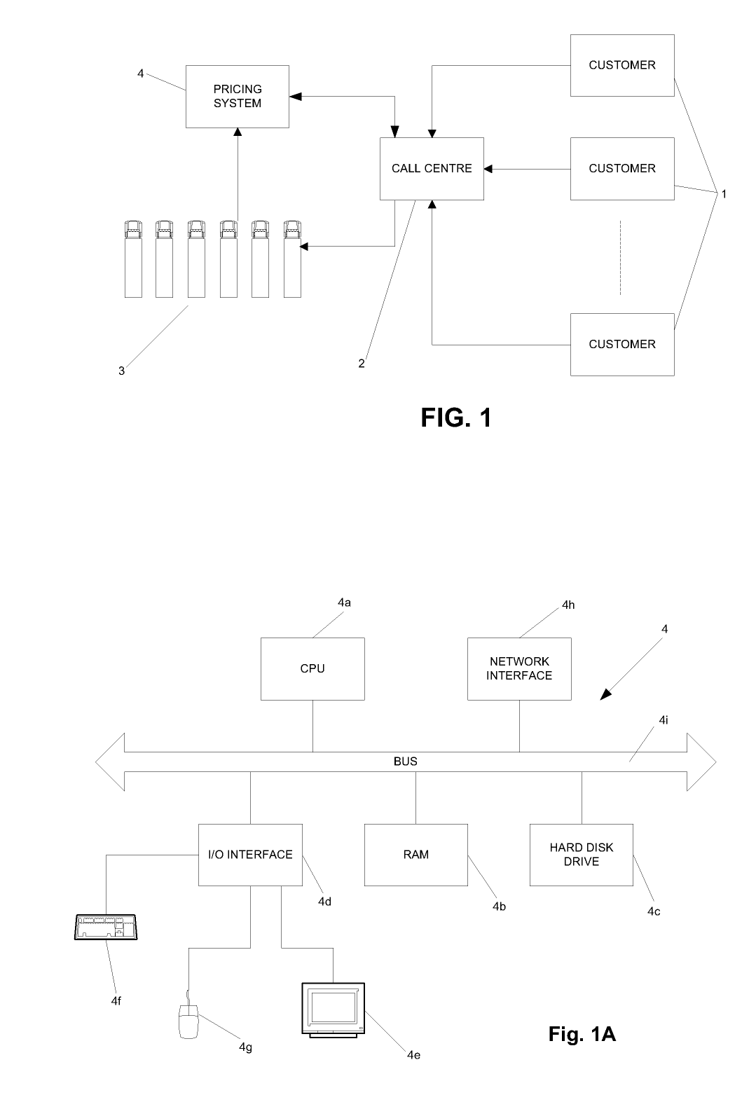

Referring to FIG. 1, an arrangement for sale of delivered fuel to a plurality of customers 1 is schematically illustrated. A call centre 2 receives telephone calls from the plurality of customers and sales agents at the call centre 2 offer each customer a sale price for the fuel to be delivered on a selected date by one of a plurality of delivery vehicles 3. If the customer accepts the offered sale price then the sale is confirmed and the delivery is booked onto an available delivery vehicle to be delivered on the selected date, otherwise the call ends with no sale being agreed. Alternatively the available delivery capacity is assigned in accordance with the sale, without assigning the sale to a particular delivery vehicle and the actual assignment of deliveries to vehicles is made on the day of delivery.

A pricing system 4 is arranged to provide suggested prices to the sales agents at the call centre 2 for each of the customers. For each customer the pricing system 4 receives various information and processes the information to determine the suggested price for the customer. In particular, the pricing system receives data identifying the customer from the call centre 2 and capacity data associated with the delivery vehicles 3, and determines the suggested prices based upon the customer information, a cost of the requested product, a delivery cost and an opportunity cost.

In general terms the opportunity cost provides an indication of profit that could be made from using the delivery capacity for the current customer to provide fuel to a potential future customer, in particular given that the plurality of delivery vehicles 3 have a finite capacity for delivery of fuel on the selected date and given that the order from the customer reduces that finite capacity. The opportunity cost therefore takes into account the capacity data associated with the delivery vehicles 3.

FIG. 1A shows a computer of the pricing system 4 in further detail. It can be seen that the computer comprises a CPU 4a which is configured to read and execute instructions stored in a volatile memory 4b which takes the form of a random access memory. The volatile memory 4b stores instructions for execution by the CPU 4a and data used by those instructions. For example, in use, the various information received by the pricing system 4 may be stored in the volatile memory 4b.

The computer of the pricing system 4 further comprises non-volatile storage in the form of a hard disc drive 4c. The various information may be stored on the hard disc drive 4c. The computer further comprises an I/O interface 4d to which are connected peripheral devices used in connection with the computer. More particularly, a display 4e is configured so as to display output from the computer. The display 4e may, for example, display the various information to a user. Additionally, the display 4e may display recommended prices generated by processing of the various information. Input devices are also connected to the I/O interface 4d. Such input devices include a keyboard 4f and a mouse 4g which allow user interaction with the computer. A network interface 4h allows the computer to be connected to an appropriate computer network so as to receive and transmit data from and to other computing devices. The CPU 4a, volatile memory 4b, hard disc drive 4c, I/O interface 4d, and network interface 4h, are connected together by a bus 4i.

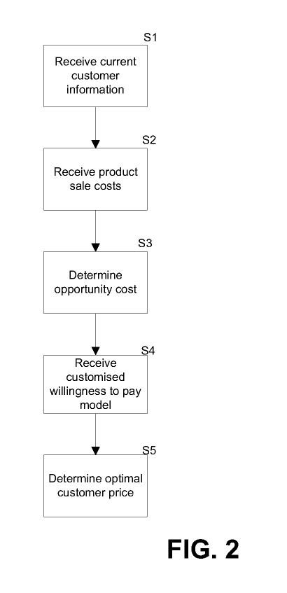

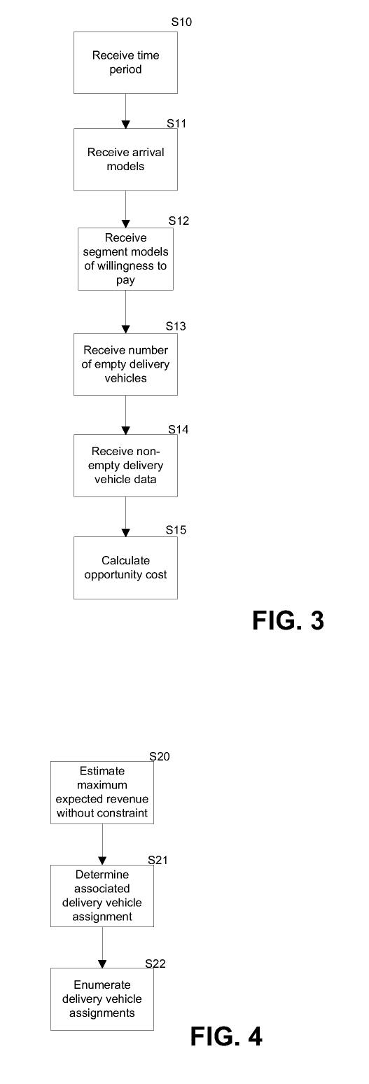

Referring to FIG. 2, processing carried out by the pricing system 4 to determine a suggested price for a customer is shown. At step S1 information associated with the customer is received including an indication of the product and delivery date requested by the customer and an identifier that allows properties associated with the customer to be determined such as a previous call and sales history for the customer. At step S2 product sale costs are received. The product sale costs include a cost for the requested product and a cost for delivery of that product. At step S3 an opportunity cost is determined based upon the customer information received at step S1 and data indicating delivery capacity. Determination of the opportunity cost is described in detail below with reference to FIG. 3.

At step S4 a customised model of willingness to pay associated with the customer and grade is received. The customised model of willingness to pay is customised to the current customer call, for example based upon previous calls and sales history for the customer and/or to a segment to which the customer is deemed to belong and/or to factors affecting current market, conditions such as current or expected weather. At step S5 an optimal customer price is determined for the current customer, delivery date and product using a one-dimensional optimisation of expected contribution to profit of the customer with respect to price p, where contribution to profit is modelled as shown in equation (1).

pr(p)*(p−costs−opp) (1)

where:
p is price;
pr(p) is the probability of conversion to a sale of the current customer at price p;
costs is the total cost associated with the product and its delivery; and
opp is the opportunity cost.

Since the product cost and delivery cost are known values the value costs is also known. The value opp is determined based upon the customer, requested grade and available delivery capacity as described below with reference to FIG. 3.

The optimal customer price is passed to the sales agent at the call centre, possibly with a range within which the sales agent may negotiate with the customer.

Referring to FIG. 3 determination of the opportunity cost of step S3 of FIG. 2 is shown. At step S10 a time period T is received, the time period indicating a finite horizon over which product purchases and bookings can be taken for the current period. At step S11 a plurality of arrival models Aᵢⱼ arranged to provide an expected rate of calls in the time period T is received.

All customers are categorised as belonging to one of a plurality of segments based upon previous calls, with each segment j generally grouping together customers sharing particular properties, for example a typical size of delivery or a likelihood of the customer placing an order after contact with the call centre, and each of the plurality of models received at step S11 is associated with a particular product i and customer segment j. The plurality of models received at step S11 comprises one model for each combination of product i and segment j and each model predicts an expected number of callers, M, for that combination of product and segment in the time period to the delivery date.

At step S12 a set of segment models of willingness to pay is received. Each of the models Fᵢⱼ in the set of segment models of willingness to pay is associated with a product i and segment j in a corresponding manner to the models received at step S10. Each of the segment models of willingness to pay is a parametric model of a probability of conversion to a sale for a customer in the segment and is a function of price p. The segment models of willingness to pay may take any convenient form such as an exponential distribution model of reservation price probability with slope parameter −b, or as a logistic distribution with mean μ and scale σ.

An expected demand rate λᵢⱼ(s) for a given product i, segment j and time period s at a particular price p may be determined for each product and segment based upon the arrival models Aᵢⱼ and willingness to pay models Fᵢⱼ received at steps S11 and S12 respectively for that combination of product and segment according to equation (2):

λᵢⱼ(s)=(Aᵢⱼ*T)*AV*Fᵢⱼ (2)

where:
Aᵢⱼ is the arrival model for product i and segment j received at step S11;
T is the remaining time period;
AV is the average volume requested per customer; and
Fᵢⱼ is the segment model of willingness to pay for product i and segment j and is a function of price.

A profit Rᵢⱼ rate can be determined by multiplying λᵢ(s) by (p−c) which provides the amount of profit per unit sale.

It will be appreciated that the time period T may comprise a plurality of sub time periods, for example a plurality of remaining days in which a product may be sold, or a plurality of remaining hours in a day in which a product may be sold, and each of the sub time periods may have a different expected number of callers M. In such a case the demand rate λᵢ(s) may be determined based upon a plurality of individual demand rates determined for each sub time period, for example by averaging the individual demand rates. Additionally or alternatively the time period T may be a proportion of a time period for which the value M is determined, for example a remaining proportion of a day. In such a case the term (M*T) may be modified to (M*T/P) where P is the total for which the value M is determined. For example, where T indicates a number of hours remaining in a day and M indicates the total number of calls expected in that day, the value P may be 24 such that the term (M*T/P) provides the expected number of calls in the remaining hours in the day.

At steps S13 and S14 delivery capacity data associated with available delivery vehicles is received. In particular, at step S13 the number n of delivery vehicles that are currently empty and therefore not assigned to a particular product i is received and at step S14 data indicating the remaining capacity δᵢ of each delivery vehicle that is assigned to a particular product i but that is not full is received.

At step S15 an opportunity cost opp is calculated based upon the data received at steps S10 to S14. As described above, the value opp provides an indication of profit that could be made from using the delivery capacity for the current customer to provide fuel to a potential future customer, and can therefore be determined according to equation (3):

opp=V_{without}V_{with} (3)

where the value V_{without} is the maximum expected revenue in the time period T without the effect on delivery capacity (as indicated by the capacity data received at steps S13 and S14) of completing the sale to the current customer and the value V_{with} is the maximum expected revenue with the effect on delivery capacity of completing the sale to the current customer.

The estimation of each of the values V_{without} and V_{with} (each having a different capacity constraint as determined by the current customer order) can be expressed as a fluid approximation problem to maximise with respect to the set of demand rates λ(s) of the form shown in equation (4).

$${max}_{\{ λ ( s ) , s ∈ [ 0 , T ] \}} \{ \begin{matrix}{\int }_{0}^{T} {\sum }_{i , j = 1}^{I , J} {R}_{ij} ( {λ}_{ij} ( s ) ) d s \vert λ ( s ) ∈ L ∀ s , \\ ∃ ( {k}_{1} … {k}_{I} ) ∈ {ℕ}^{I} \text{?} {\int }_{0}^{T} {\sum }_{j = 1}^{J} {λ}_{b} ( s ) d s \leq \text{?} + \text{?} \cdot \\ c Max ∀ i and {\sum }_{i = 1}^{I} \text{?} = n\end{matrix} \} \\ \text{?} \text{indicates text missing or illegible when filed} \qquad ( 4 )$$

where:
kᵢ, i∈{l, . . . , l}, is the number of delivery vehicles assigned to product i;
(k₁, . . . kₗ) is an assignment of delivery vehicles to products;
T is a finite horizon over which product purchases and bookings can be taken for the current period;
λᵢⱼ(s) is the demand rate for product i and segment j∈{1, . . . , J} at time s;
Rᵢⱼ(λᵢⱼ(s)) is the profit rate at demand rate λᵢⱼ(s);
cMax is the maximum number of delivery slots in a delivery vehicle;
n is the number of empty delivery vehicles;
δᵢ is the remaining capacity in a truck that is partially full with product i; and
L is the set of permissible values for the demand rates λᵢⱼ(s), determined by the permissible values for the corresponding prices.

The remaining capacity for carrying products for the current period, determined by the values n and δᵢ, varies for the estimation of V_{without} compared to the estimation of V_{with} and provides different values for each estimation.

The fluid approximation of equation (4) cannot be directly evaluated. However, from equation (4) it can be seen that there exists an assignment of delivery vehicles K=(k_{1,} . . . kₗ) such that Σᵢ₌ₗ^{l}kᵢ=n, that provides the maximal value of equation (4) for each of V_{without} and V_{with}, and the solution to equation (4) can therefore be viewed as shown in equation (5):

$${V}_{\{ with , without \}} = {max}_{K ∈ {ℕ}^{j}} \{ {V}_{k} \} \qquad ( 5 )$$

where Vₖ is as shown in equation (6):

$${V}_{k} = {\sum }_{i = 1}^{I} {V}_{{k}_{i}} \qquad ( 6 )$$

and Vₖ_{ᵢ} is the value of the fluid approximation problem shown in equation (7).

$${V}_{{k}_{i}} = {max}_{\{ λ ( s ) , s ∈ [ 0 , T ] \}} \{ {\int }_{0}^{T} {\sum }_{j = 1}^{J} {R}_{ij} ( {λ}_{ij} ( s ) ) d s \vert {\sum }_{j = 1}^{J} {λ}_{ij} ( s ) \leq ( {δ}_{i} + c Max \cdot {k}_{i} ) , {λ}_{ij} ( s ) ∈ L ∀ s \} \qquad ( 7 )$$

The fluid approximation problem of equation (4) can therefore be decomposed according to equations (5) (6) and (7) into a plurality of fluid approximation problems that enumerate the possible delivery vehicle assignments K={k∈N^{I}|Σᵢ₌₁^{I}kᵢ=n} to products i, and in which each fluid approximation has J variables which can be considered as separate products.

As shown in Gallego, G., van Ryzin, G.: “Optimal dynamic pricing of inventories with stochastic demand over finite horizons”, Management Science, 1994, pp. 999-1020, Gallego, G., van Ryzin, G.: “A multiple product dynamic pricing problem and its applications to network yield management”, Operations Research, 1997, pp. 24-41, which is herein incorporated by reference, the demand rate λᵢⱼ for each segment and grade that provides the optimal solution to the fluid approximation of equation (7) is constant over time and λᵢⱼ∈E [0, λᵢⱼ*], where λᵢⱼ* is a finite point-wise maximiser of Rᵢⱼ and which exists by regularity of Rᵢⱼ . It is therefore sufficient to maximise total profit over a space of constant demand rates as shown in equation (8).

$${V}_{{k}_{i}} = {max}_{\{ {λ}_{ij} \}} \{ T {\sum }_{j = 1}^{J} {R}_{ij} ( {λ}_{ij} ) : T \vert {\sum }_{j = 1}^{J} {λ}_{ij} ( s ) \leq ( {δ}_{i} + c Max \cdot {k}_{i} ) , {λ}_{ij} ∈ [ 0 , {λ}_{ij}^{*} ] \} \qquad ( 8 )$$

The solution to the multi-product fluid approximation is described in Maglaras, C., Meissner, J.: “Dynamic pricing strategies for multiproduct revenue management problems”, Manufacturing & Service Operations Management, 2006, pp. 136-148 which is herein incorporated by reference.

The value V_{without} described above is the maximum value Vₖ for each possible truck assignment in the set K without the current customer order and the value V_{with} is the maximum value Vₖ for each possible truck assignment with the current customer order and once V_{with} and V_{without} have been determined, the value opp can be determined in a straightforward manner according to equation (3). As described above, the value opp can be used in a one-dimensional optimisation of expected contribution to profit of the customer with respect to price p, where contribution to profit is modelled as shown in equation (1) to determine a price p for the current customer.

Alternatively, in some embodiments where a price p is provided to each customer in a particular segment rather than on an individual customer basis, the price p can be determined for each segment directly from the optimal demand rates λᵢⱼ(s) associated with the value V_{without}. In particular, the optimal demand rate \sqrt{λ}ᵢⱼ(s) for each product i and segment j associated with the value V_{without} is associated with a particular willingness to pay Fᵢⱼ by the relationship shown in equation (2), and since the willingness to pay is a function of price p, equation (2) provides an optimal price \sqrt{p}ᵢⱼ for product i and segment j corresponding to the optimal demand rate \sqrt{λ}ᵢⱼ(s).

The above description of a determination of a value opp requires calculation of two values, V_{with} and V_{without} , each of which requires I values Vₖ to be first determined, and as such the determination of the value opp described above is typically computationally expensive. As such, methods for reducing the computation required to estimate an opportunity cost will now be described.

In the above description two values V_{with} and V_{without} are determined. However where it can be reasonably assumed that all callers request the same volume of delivered fuel and where a closed form expression for the model of willingness to pay is used, such as for example an exponential distribution model of reservation price probability with slope parameter −b, or a logistic distribution with mean μ and scale σ, a value opp may be estimated according to equation (9) below:

opp=R′ᵢⱼ(\sqrt{λ}ᵢⱼ) (9)

where:
R′ᵢⱼ is the derivative of the profit rate function Rᵢⱼ; and
\sqrt{λ}ᵢⱼ(s) is the optimal demand rate associated with the value V_{K} that provides the value V_{without} in equation (5) for the product i requested by the current customer in segment j.

It will be appreciated that in general there will be a relatively large number of products I and empty delivery vehicles n to which the products can be assigned. Indeed, it can be shown that the number of points in the set of possible delivery vehicle assignments K is as shown in equation (10).

$$( \begin{matrix}n + I - 1 \\ I - 1\end{matrix} ) \qquad ( 10 )$$

The number of delivery vehicle assignments that are evaluated to determine the maximum value corresponding to the value V_{without} and V_{with} can be reduced as will now be described with reference to FIG. 4.

At step S20 the maximum expected revenue without grade constraint on delivery vehicle V_{unconstrained} is estimated. That is, a maximum expected revenue that could be generated if it were possible to carry more than one product in a single delivery vehicle is estimated based upon the number of empty delivery vehicles n at the time of the current customer call. The maximum expected revenue without grade constraint on delivery vehicle is determined by solving the fluid approximation of equation (11).

$$V = {max}_{\{ {λ}_{ij} \}} \{ T {\sum }_{i , j = 1}^{I , J} {R}_{ij} ( {λ}_{ij} ) : T \vert {\sum }_{i , j = 1}^{I , J} {λ}_{ij} ( s ) \leq C , {λ}_{ij} ∈ [ 0 , {λ}_{ij}^{*} ] \} \qquad ( 11 )$$

It can be seen that equation (11) is a maximisation over all products and segments, i, j respectively, for the total capacity for delivery C, determined by n*cMax+Σᵢ₌ₗ^{l}δᵢ, where cMax is the capacity of each truck. This differs from equation (8) which is over all segments j for a single product i for the capacity available for delivery of product i as determined by the value k, in the assignment k currently being evaluated.

At step S21 a delivery vehicle assignment is determined based upon the set of optimal demand rates λ^{opt} associated with the value V determined according to equation (11) at step S20. The delivery vehicle assignment is determined by solving equation (12) to find nᵢ^{opt} and rᵢ^{opt} for each i:

Σⱼλᵢⱼ^{opt}=((nᵢ^{opt}+rᵢ^{opt})cMax+δᵢ)/T (12)

where:
λᵢⱼ^{opt} is the component of λ^{opt} associated with product i and segment j;
nᵢ^{opt} is the number of delivery vehicles completely filled with product i;
0≦rᵢ^{opt}<1 is the fraction of a truck partially filled with grade i which is required given that λ^{opt} is associated with the solution to the unconstrained problem of equation (11);
cMax is the capacity of a delivery vehicle as before; and
δᵢ is the units of capacity in a delivery vehicle partially filled with product i at the start of the period T.

It follows from equation (12) that equation (13) holds:

$${\sum }_{i = 1}^{I} ( {n}_{i}^{opt} + {r}_{i}^{opt} ) = n \qquad ( 13 )$$

where n is the number of empty delivery vehicles.

Since the n empty delivery vehicles at the start of the period are completely filled by the end of the period the remaining partial assignments rᵢ^{opt} from equation (12) across all grades together fill a whole number of delivery vehicles R and that this number is strictly less than the number of grades because each rᵢ^{opt}<1, that is equation (14) also holds:

$${\sum }_{i = 1}^{I} {r}_{i}^{opt} = R \qquad ( 14 )$$

where R is an integer less than I.

At step S22 the set of delivery vehicle assignments to be evaluated K* is determined. The set K* is a subset of the set K and includes those points in K that lie in the vicinity of the maximum of the delivery vehicle assignment associated with the maximum expected revenue without constraint determined in equation (11). The set K* is given by (15):

K*={n^{opt}+\hat{k}|Σᵢ₌₁^{l}\hat{k}ᵢ=R} (15)

where:
n^{opt} is the vector with components nᵢ^{opt} from equation (12);
\hat{k}∈{0,1}^{l}; and
R is as defined in equation (14).

The term \hat{k} in (15) enumerates the partial assignments rᵢ^{opt} from the unconstrained problem set variously to \hat{k}ᵢ=0 or 1.

It can be shown that the set K* comprises points (16), providing a significant improvement on the points (10) of the set K.

$$( \begin{matrix}I \\ R\end{matrix} ) \qquad ( 16 )$$

The processing of FIG. 4 can be used to determine the values V_{without} and V_{with} and the value opp can be determined according to equation (3) using those values. Alternatively the processing of FIG. 4 can be used to determine the value V_{without} and the value opp can be determined according to the processing described above with reference to equation (9).

The above description is based upon a single depot, however it will be appreciated that in general there will exist a plurality of available depots from which an order may be fulfilled, with each depot having an associated number of available delivery vehicles and corresponding capacity. In such a case the above processing may be carried out for each depot to determine an opportunity cost associated with each depot and associated set of prices. The sales agent will typically select one of the depots from which to make the delivery based upon a location associated with the customer.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of generating fuel price data for at least one fuel type of a plurality of fuel types, the method being implemented in a computer comprising a memory in communication with a processor, the method comprising:
receiving, as input to the processor, unassigned delivery capacity data, the unassigned delivery capacity data indicating delivery capacity available for any one of said plurality of fuel types;
receiving, as input to the processor, assigned delivery capacity data, the assigned delivery capacity data indicating, for each fuel type of said plurality of fuel types, delivery capacity only available for said fuel type of said plurality of fuel types; and
processing, by the processor, said assigned delivery capacity data and said unassigned delivery capacity data to generate said fuel price data for said at least one fuel type.

2. A computer-implemented method according to claim 1, further comprising:
receiving, as input to the processor, a request for a delivery of one of said plurality of fuel types, said request being associated with a quantity of fuel;
wherein said processing comprises:
determining, by the processor, a maximum expected revenue based upon said unassigned delivery capacity data and said assigned delivery capacity data; and
determining an effect upon said maximum expected revenue associated with accepting said request.

3. A computer-implemented method according to claim 2, wherein determining said effect upon said maximum expected revenue comprises:
determining, by the processor, a further maximum expected revenue, the further maximum expected revenue being based upon said assigned delivery capacity data, said unassigned delivery capacity data and said quantity of fuel associated with said request; and
determining a difference between the first maximum expected revenue and the second expected maximum revenue.

4. A computer-implemented method according to claim 2, wherein said effect upon maximum expected revenue is determined based upon a rate of change of a profit rate associated with a maximum expected revenue without accepting said request.

5. A computer-implemented method according to claim 2, wherein determining a maximum expected revenue comprises:
processing, by said processor, at least one model defining a relationship between a demand rate associated with a fuel type of said plurality of fuel types, said unassigned delivery capacity data and said assigned delivery capacity data.

6. A computer-implemented method according to claim 5, wherein said model defines a fluid approximation problem.

7. A computer-implemented method according to claim 5, further comprising:
receiving, as input to the processor, a plurality of arrival models, each of said demand rates having an associated arrival model, each of said arrival models being arranged to provide an expected rate of requests associated with said demand rate; and
receiving, as input to the processor, a plurality of willingness to pay models, each of said demand rates having an associated willingness to pay model, each of said willingness to pay models being arranged to provide a probability of conversion of a request for a delivery associated with a price and said demand rate;
wherein said demand rate for each of said plurality of fuel types is based upon said arrival model associated with said fuel type and said willingness to pay models associated with said fuel types.

8. A computer-implemented method according to claim 7, wherein each request is associated with a segment of a plurality of segments, each segment being associated with a classification of requests, and wherein said demand rate is associated with a fuel type of said plurality of fuel types and a segment of said plurality of segments.

9. A computer-implemented method according to claim 5, wherein processing at least one model defining a relationship between a demand rate associated with each of said plurality of fuel types comprises:
generating, by said processor, a plurality of assignments assigning said unassigned delivery capacity to said plurality of fuel types;
for each of said generated plurality of assignments, processing a model associated with a demand rate associated with each of said plurality of fuel types, said assigned delivery capacity and said assignment to determine an expected revenue associated with said assignment; and
determining a maximum one of said expected revenues associated with said assignments.

10. A computer-implemented method according to claim 9, wherein said unassigned delivery capacity comprises a plurality of sub capacities, and wherein each of said assignments assigns the whole of a sub capacity to one of said plurality of fuel types.

11. A method according to claim 10, wherein said sub capacities correspond to delivery vehicles.

12. A computer-implemented method according to claim 10, wherein generating a plurality of assignments comprises:
processing, by said processor, a model defining a relationship between a demand rate associated with each of said plurality of fuel types and said unassigned delivery capacity to determine an unconstrained expected revenue;
determining, by the processor, an unconstrained assignment assigning said delivery capacity to said plurality of fuel types based upon said unconstrained expected revenue; and
generating said plurality of assignments based upon said unconstrained assignment.

13. A computer-implemented method according to claim 12, wherein generating said plurality of assignments based upon said unconstrained assignment comprises:
determining, by the processor, a sub capacity assigned to more than one of said fuel types in said unconstrained assignment; and
generating, by the processor, for each of said fuel types assigned to said sub capacity, an assignment in which said sub capacity is assigned to said fuel type.

14. A computer-implemented method according to claim 2, wherein said processing further comprises:
performing, by the processor, an optimisation operation, said optimisation operation being based upon said effect upon said maximum expected revenue associated with accepting said request.

15. A computer-implemented method according to claim 14, wherein said optimisation operation is further based upon a cost associated with said request.

16. A computer-implemented method according to claim 14, wherein said optimisation operation is further based upon a conversion model, said conversion model modelling a relationship between a price and a probability of conversion to sale of said request.

17. A computer readable medium carrying a computer program comprising computer readable instructions configured to cause a computer to carry out a method according to claim 1.

18. A computer apparatus for generating fuel price data for at least one fuel type for a delivery network arranged to deliver a plurality of fuel types, the apparatus comprising:
a memory storing processor readable instructions; and
a processor arranged to read and execute instructions stored in said memory;
wherein said processor readable instructions comprise instructions arranged to control the computer to carry out a method according to claim 1.

19. A computer-implemented method of generating fuel price data for a fuel type, the method being implemented in a computer comprising a memory in communication with a processor, the method comprising:
receiving, as input to the processor, customer data indicating a customer request for fuel of said fuel type at a first time;
receiving, as input to the processor, capacity data indicating assigned delivery capacity at said first time; and
generating, by the processor, said fuel price data based upon said customer data and said capacity data.

20. A computer-implemented method according to claim 19, wherein said customer data is received at a first node from a second node and the method further comprises:
transmitting the generated fuel price data to said second node.

21. A computer-implemented method according to claim 20, wherein said capacity data is received from a third node.

22. A computer-implemented method according to claim 20, wherein said first node is a computer and said second node is a computer.

23. A computer-implemented method according to claim 20, wherein said data is transmitted over a network.

24. A computer-implemented method according to claim 21, wherein said third node is a computer.

25. A computer-implemented method according to claim 19, wherein said capacity data further indicates unassigned delivery capacity at said first time.

26. A computer-implemented method according to claim 19, wherein said generating comprises:
determining, by the processor, a maximum expected revenue for said first time based upon said capacity data; and
determining an effect upon said maximum expected revenue associated with accepting said request.

27. A computer-implemented method according to claim 19, wherein said customer data further indicates a segment associated with said customer, said segment being associated with historical customer requests for fuel received from said customer.

28. A computer readable medium carrying a computer program comprising computer readable instructions configured to cause a computer to carry out a method according to claim 19.

29. A computer apparatus for generating fuel price data for at least one fuel type for a delivery network arranged to deliver a plurality of fuel types, the apparatus comprising:
a memory storing processor readable instructions; and
a processor arranged to read and execute instructions stored in said memory;
wherein said processor readable instructions comprise instructions arranged to control the computer to carry out a method according to claim 19.

30. A computer-implemented method of determining an effect upon maximum expected revenue of a request for a delivery of one of a plurality of fuel types, the request being associated with a quantity of fuel, the method being implemented in a computer comprising a memory in communication with a processor, the method comprising:
receiving, as input to the processor, unassigned delivery capacity data, the unassigned delivery capacity data indicating delivery capacity available for any one of said plurality of fuel types;
processing, by said processor, a model defining a relationship between a demand rate associated with each of said plurality of fuel types and said unassigned delivery capacity to determine an unconstrained expected revenue;
determining, by the processor, an unconstrained assignment assigning said delivery capacity to said plurality of fuel types based upon said unconstrained expected revenue; and
generating, by said processor, a plurality of assignments assigning said unassigned delivery capacity to said plurality of fuel types based upon said unconstrained assignment; and
determining said effect upon maximum expected revenue based upon said plurality of assignments.

31. A computer-implemented method according to claim 30, wherein said unassigned delivery capacity comprises a plurality of sub capacities, and wherein each of said assignments assigns the whole of a sub capacity to one of said plurality of fuel types.

32. A method according to claim 31, wherein said sub capacities correspond to delivery vehicles.

33. A computer-implemented method according to claim 31, wherein generating said plurality of assignments based upon said unconstrained assignment comprises:
determining, by the processor, a sub capacity assigned to more than one of said fuel types in said unconstrained assignment; and
generating, by the processor, for each of said fuel types assigned to said sub capacity, an assignment in which said sub capacity is assigned to said fuel type.

34. A computer readable medium carrying a computer program comprising computer readable instructions configured to cause a computer to carry out a method according to claim 30.

35. A computer apparatus for generating fuel price data for at least one fuel type for a delivery network arranged to deliver a plurality of fuel types, the apparatus comprising:
a memory storing processor readable instructions; and
a processor arranged to read and execute instructions stored in said memory;
wherein said processor readable instructions comprise instructions arranged to control the computer to carry out a method according to claim 30.
